(19) United States
(12) Patent Application Publication
(10) Pub. No.: US 2009/0235535 A1
(43) Pub. Date: Sep. 24, 2009

(54) Scraper

(75) Inventors: Michael Circosta, Valhalla, NY (US); Anthony Di Bitonto, Brooklyn, NY (US); Anton Ljunggren, New York, NY (US); Jonathan N. Cedar, Scarsdale, NY (US); Alexander H. Drummond, Brooklyn, NY (US)

Correspondence Address: SEYFARTH SHAW LLP, 131 S. DEARBORN ST., SUITE 2400, CHICAGO, IL, 60603-5803, US

(73) Assignee: HELEN OF TROY LIMITED, a Barbados company

(21) Appl. No.: 12/079,051

(22) Filed: Mar. 24, 2008

(51) Int. Cl. B26B 29/02

(52) U.S. Cl. 30/162

(57) ABSTRACT

A tool for releasably securing a blade is provided. The tool includes a housing, a blade retracting mechanism, a blade retaining portion, a blade opening and an actuator. The blade retracting mechanism is movable between a retracted position and a working position. The blade retaining portion is located on the blade retracting mechanism. The blade retaining portion has at least two blade retaining surfaces cooperating to releasably secure the blade to the blade retracting mechanism. The blade retaining surfaces are located a first distance from one another in a blade retaining position and located a second distance from one another in a blade releasing position, the second distance being greater than the first distance. The blade opening is defined by the housing for inserting and removing the blade from the blade retaining portion. The actuator is for manipulating the blade retaining mechanism between the retracted position and the working position.

### FIELD OF THE INVENTION

This invention relates generally to a scraping tool, and in more particular applications to a scraping and/or cutting tool with a releasable blade which can be retracted within a housing.

### BACKGROUND

Scraping tools can be used for a variety of purposes, such as, for example, removing paint, adhesives, decals, wallpaper and the like from surfaces such as glass and walls. These tools often include a gripping portion whereby a user can grasp the tool comfortably and safely, and a blade portion for scraping the desired surface. Additionally, these tools may, in some instances, be used for cutting.

Scraping tools can become dull or worn at the blade portion as a result of scraping or cutting the respective surfaces. The speed at which the blade becomes dull can depend on a number of factors, such as the surface and the material which is being scraped from the surface. Some scraping tools have been designed to include replaceable blades whereby the user can disassemble the tool and replace the blade when necessary. However, oftentimes, these tools require significant disassembly of the tool to replace the blade which can be time consuming.

Furthermore, blade removal and replacement oftentimes requires the user to exert significant force to separate the blade from the tool and install a new blade. This can be dangerous for the user should the user's hand slip and/or slide along the blade.

Moreover, as some tools have been developed with replaceable blades, it has become necessary to carry extra replacement blades. Oftentimes, the tool will include an extra carrying case that may be attached to the tool or include an internal compartment for carrying extra blades.

Furthermore, scraping tools are used by a variety of individuals and may be carried in the user's pocket or in a tool belt. However, the blade can injure the user if the blade is not properly covered when not in use. Therefore, some tools have been developed that include covers for the blade or have been designed such that the blade is retractable into a housing.

### SUMMARY

In one form, a tool for releasably securing a blade is provided. The tool includes a housing, a blade retracting mechanism, a blade retaining portion, a blade opening and an actuator. The blade retracting mechanism is movable between a retracted position and a working position. The blade retaining portion is located on the blade retracting mechanism. The blade retaining portion has at least two blade retaining surfaces cooperating to releasably secure the blade to the blade retracting mechanism. The blade retaining surfaces are located a first distance from one another in a blade retaining position and located a second distance from one another in a blade releasing position, the second distance being greater than the first distance. The blade opening is defined by the housing for inserting and removing the blade from the blade retaining portion. The actuator is for manipulating the blade retaining mechanism between the retracted position and the working position.

According to one form, a tool for releasably securing a blade is provided. The tool includes a housing, a blade retracting mechanism, a blade retaining portion, a blade opening, a first actuator and a second actuator. The blade retracting mechanism is movable between a retracted position and a working position. The blade retaining portion is located on the blade retracting mechanism. The blade retaining portion has at least two blade retaining surfaces movable between a blade releasing position and a blade retaining position. The blade opening is defined by the housing for inserting and removing the blade from the blade retaining portion. The first actuator is for manipulating the blade retracting mechanism between the retracted position and the working position. The second actuator is for manipulating the blade retaining surfaces between the blade releasing position and the blade retaining position.

In accordance with one form, a tool for releasably securing a blade is provided. The tool includes a housing, a blade retracting mechanism, a blade retaining portion, a blade opening and an actuator. The blade retracting mechanism is movable between a retracted position, a working position and a blade releasing position. The blade retaining portion is located on the blade retracting mechanism. The blade retaining portion has at least two blade retaining surfaces movable between the blade releasing position and a blade retaining position. The blade opening is defined by the housing for inserting and removing the blade from the blade retaining portion. The actuator is for manipulating the blade retracting mechanism between the retracted position, the working position and the blade releasing position.

According to one form, the blade is substantially enclosed within the housing and is located inwardly relative to the blade opening when in the retracted position.

In one form, the actuator is a button operably coupled to the blade retracting mechanism.

In accordance with one form, the tool further includes a storage drawer and an extension arm extending therefrom, wherein the actuator is the drawer operably coupled to the blade retracting mechanism via the extension arm.

According to one form, the blade retaining portion includes a lever arm to manipulate at least one of the blade retaining surfaces.

In accordance with one form, the lever arm contacts a portion of the housing to pivot at least one of the blade retaining surfaces to the blade releasing position.

In one form, the tool further includes a storage drawer and an extension arm extending therefrom, wherein the arm contacts a portion of the extension arm to pivot at least one of the blade retaining surfaces to the blade releasing position.

According to one form, the blade retaining surfaces are biased to the blade retaining position by a spring.

Other forms are also contemplated as understood by those skilled in the art.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a top view of one form of a scraper with a retractable and replaceable blade;

FIG. 2 is a cross-sectional view taken along line 2-2 of FIG. 1 with the scraper in a retracted position;

FIG. 3 is a cross-sectional view taken along line 2-2 of FIG. 1 with the scraper in a working position;

FIG. 4 is a cross-sectional view taken along line 2-2 of FIG. 1 with the scraper in a blade releasing position;

FIG. 5 is a top view of an alternative form of a scraper with a retractable and replaceable blade;

FIG. 6 is a cross-sectional view taken along line 6-6 of FIG. 5;

FIG. 7 is an enlarged view of the encircled area of FIG. 6;

FIG. 8 is a cross-sectional view taken along line 6-6 of FIG. 5 with the scraper in a retracted position;

FIG. 9 is a cross-sectional view taken along line 6-6 of FIG. 5 with the scraper in a working position;

FIG. 10 is a cross-sectional view taken along line 6-6 of FIG. 5 with the scraper in a blade releasing position; and,

FIG. 11 is a perspective view of one form of a blade retracting mechanism.

### DETAILED DESCRIPTION

One form of a scraper 20 is illustrated in FIG. 1. Generally, the scraper 20 includes a housing 22, a blade retracting mechanism 24, a blade retaining portion 26, a blade opening 28, and an actuator 30, as best seen in FIGS. 2-4. One or more blades 32 may be used in combination with the scraper 20 to scrape and or cut a surface. It should be understood that while blade 32 is illustrated as being a single-edged blade, other forms of blades may also be utilized as understood by those skilled in the art.

The housing 22 includes an interior portion 34, and in some instances, such as shown in FIGS. 2-4, includes one or more protrusions 36. In one form, the housing 22 is shaped to be comfortably grasped in a user's hand. In another form, the housing 22 is shaped to be grasped in a user's hand in multiple positions. The function of the interior portion 34 and protrusion 36 will be discussed in more detail below with reference to the operation of the scraper 20.

The blade retracting mechanism 24 may comprise multiple components, as illustrated in FIGS. 2-4. In this form, the blade retracting mechanism 24 includes the blade retaining portion 26 located on the blade retracting mechanism 24. The blade retaining portion 26 includes at least two blade retaining surfaces 38,40. The blade retaining surfaces 38,40 can cooperate to releasably secure the blade 32 to the scraper 20. The blade retaining portion 26 and blade retaining surfaces 38,40, may include a recessed portion 42 to provide space for and engage a holding portion 44 of the blade 32. As shown in FIG. 2-4, each of the blade retaining surfaces 38,40 includes a recessed portion 42. However, it should be understood that only one of the blade retaining surfaces 38,40 may include a recessed portion 42 and/or neither of the blade retaining surfaces 38,40 may include a recessed portion 42.

In one form, the blade retaining surfaces 38,40 may be configured to cooperate with one another via a pivot 46, as shown in FIGS. 2-4. The pivot 46 may form part of one or both of the blade retaining surfaces 38,40 and/or may be a separate component to operably couple the blade retaining surfaces 38,40. Alternatively, the blade retaining surfaces 38,40 may be configured in other manners known by those skilled in the art to cooperate with one another to releasably secure the blade 32.

The blade retracting mechanism 24 may include one or more lever arms 48 that may be used to manipulate the blade retaining surfaces 38,40 at the blade retaining portion 26. As shown in FIGS. 2-4, the scraper has two lever arms 48, one coupled to each of the blade retaining surfaces 38,40. The function of the lever arms 48 will be discussed in more detail below with regards to the operation of the scraper 20.

In one form, the blade opening 28 is defined by the housing 22. The blade opening 28 can be utilized to insert and remove the blade 32 from the scraper 20. The blade opening 28 also provides access for the blade 32 to be retracted and extended from the housing to scrape a surface. The blade opening 28 may also include additional structure and features such as a cover (not shown) which may be used to cover the blade opening 28. It should be noted that the blade opening 28 should be large enough to permit the blade 32 and/or part of the blade retaining portion 26 to pass through. However, it should be understood that the blade opening 28 may be modified as understood by those skilled in the art.

The actuator 30 may take a variety of forms and may include additional structure as understood by those skilled in the art. In one form, as illustrated in FIGS. 2-4, the actuator 30 is a button 50. The actuator 30 can be guided by a slot 52, as shown in FIG. 1. The slot 52 may take the form of an opening in the housing 22 whereby the actuator 30 is guided along a path. Additionally, the slot 52 may include additional features, such as stops or locks (not shown) to provide feedback to the user indicating movement of the actuator 30 along the slot 52. The stops or locks can also provide resistance such that the actuator 30 is not moved along the slot 52 unintentionally.

The scraper 20 may also include additional structures or features as understood by those skilled in the art. For example, the scraper 20 may include one or more biasing structures 54. For example, as shown in FIGS. 2-4, the scraper 20 includes a spring 56 to bias the blade retaining surfaces 38,40 via the lever arms 48. Additionally, further biasing structures may be included to bias other components, such as to bias the actuator 30 in one or more directions, and for other structures, as understood by those skilled in the art. The scraper 20 may also include slots and grooves to guide the various components in desired directions or configurations and permit the components to slide, such as described for the actuator 30. The scraper 20 may also include protrusions 60, as shown in FIG. 11, that may be used to cooperate with one or more apertures 62 in the blade 32 to better secure the blade 32 and prevent it from moving while in operation. Additional features and structures may also be included as understood by those skilled in the art.

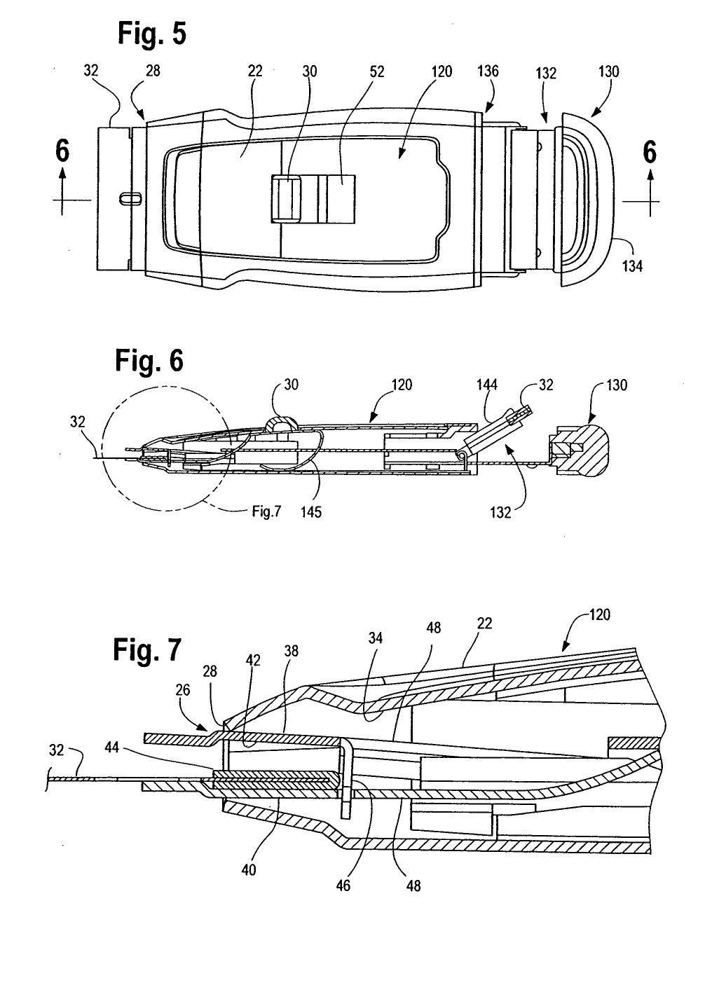

Another form of a scraper is illustrated in FIG. 5 as scraper 120. Scraper 120 contains many of the same or similar features as described above for scraper 20 with the common numbers used to designate the similar features. For example, scraper 120 includes the housing 22, the blade retracting mechanism 24, the blade retaining portion 26, the blade opening 28 and the actuator 30. However, it should be understood that the shape and design of the features found in scraper 120 may be modified slightly compared to the same features found in scraper 20. Furthermore, the scraper 120 need not include all of the features described for scraper 20. For example, scraper 120 may not include protrusions 36, as shown in scraper 20. However, such features may be include if desired.

Scraper 120 also includes further features, such as a second actuator 130 and a blade drawer or storage area 132. The second actuator 130 may take a variety of forms. As shown in FIG. 5, the second actuator 130 is a cover 134 for a rear portion 136 of the scraper 120. The second actuator 130 may also be movable as a handle to provide access to the blade storage area 132.

As best seen in FIG. 11, the second actuator 130 is operably coupled to one or more extension arms 138. The extension arms 138 are configured to manipulate the blade retracting mechanism 24. As shown in FIG. 11, in one form, the scraper 120 includes two extension arms 138 with a cross member 140. While FIG. 11 illustrates two extension arms 138, it should be understood by those skilled in the art that one or more extension arms 138 may be utilized, with or without a cross member 140. The function of the extension arms 138 will be discussed in more detail below with regard to the operation of the scraper 120.

The storage area 132 can be utilized to store one or more extra blades 32 within the housing 22. In one form, the storage area 132 is simply a recessed area wherein blades 32 can be placed. Individual blades 32 and/or one or more boxes 142 of blades can be placed in the storage area 132. In one form, the blade storage area 132 includes additional features, such as blade carrier 144. The blade carrier 144 can be designed to provide an area to secure the extra blades 32 or boxes 142 within the storage area 132. Furthermore, the blade carrier 144 can be designed to pop up when the blade storage area 132 is exposed outside of the housing 22. In this form, one or more biasing structures, such as springs (not shown) can be utilized to bias the blade carrier 144. Alternatively, grooves or the like can be provided such that the blade carrier 144 follows the groove to pop up when exposed, as understood by those skilled in the art. Additional biasing structure, such as bias member 145 can be utilized to bias the actuator 30.

The operation of these structures will now be discussed in more detail below with reference to the appropriate figures. Referring to FIGS. 2-4, the scraper 20 is illustrated in the retracted, working and blade releasing positions, respectively. As seen in FIG. 2, the scraper 20 is shown in the retracted position. The blade 32 is secured to the blade retracting mechanism 24 such that the blade 32 is substantially within the housing 22. It should be noted that the scraper 20 may be positioned in the retracted position without having any blades secured to the blade retracting mechanism 24, such that the scraper does not contain a working blade.

In the retracted position, the blade retaining surfaces 38,40 secure the blade 32 at the blade retaining portion 26. The biasing member 54 provides force to position the blade retaining surfaces 38,40 a first distance from one another, thereby securing the blade 32 while in the retracted position. It should be noted that the actuator 30 is located towards a rear portion of the scraper, away from the blade opening 28.

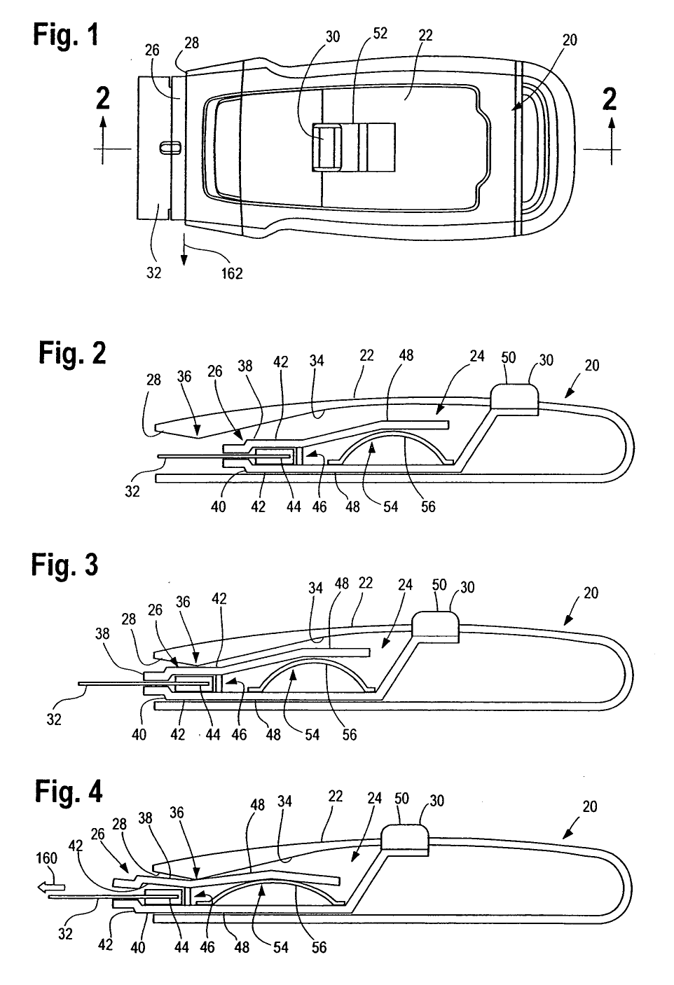

Referring to FIG. 3, the scraper has been manipulated to the working position as the actuator 30 has been moved towards the blade opening 28. The actuator 30 is operably coupled to the blade retracting mechanism 24 such that movement of the actuator 30 results in movement, such as lateral movement, of the blade retracting mechanism 24, and ultimately the blade 32. The blade retaining surfaces 38,40 are in a blade retaining position. While the biasing member 54 still provides force to bias the blade retaining surfaces 38,40 to secure the blade 32, additional force is provided from the interior 34 of the housing 22. As discussed above, the interior can include one or more protrusions 36. As best seen in FIG. 3, these protrusions 36 can provide additional force to secure the blade 32 when in the working position. Because of the positioning of the blade retaining surfaces 38,40 and the pivot 46 relative to the interior 34 and/or the protrusions 36, a clamping force results at the blade 32. In the working position, the scraper 20 and blade 32 are subjected to varying amounts of force when in use to scrape surfaces. The interior 34, as well as the protrusions 36 (when included), can provide extra clamping force via the blade retaining portion 26 to help prevent the blade from becoming loose or dislodged from the scraper 20.

However, it should be noted that the protrusions 36 are not necessary and the shape of the interior 34 can provide sufficient clamping force. In this manner, it should be noted that in one form, the interior 34 of the housing narrows near the blade opening 28. This narrowing shape can be used with or without the protrusions 36. Alternatively, the interior 34 does not have to narrow, but instead, protrusions 36 can be included to provide additional clamping force.

The actuator 30 may be moved even further towards the blade opening 28 to the blade releasing position, as shown in FIG. 4. As seen in this figure, at least a part of the blade retaining portion 26 extends through the blade opening 28 to permit removal and replacement of the blade 32. In one form, the blade retaining surfaces 38,40 are located a second distance from one another which is greater than the first distance when in the retracted and/or the working positions. In one form, the second distance is large enough such that the blade 32 can be removed by pulling the blade in the direction indicated by arrow 160. Alternatively, the blade retaining portion 26 can be designed to extend far enough through the blade opening 28 such that the blade 32 can be removed by moving the blade 32 in a direction indicated by arrow 162 in FIG. 1.

The blade 32 can be removed as the blade retaining surfaces 38,40 are separated. In one form, the blade retaining surfaces 38,40 are separated as a result of the interior 34 and/or protrusions 36 contacting the blade retaining surfaces 38,40 relative to the pivot 46. For example, the interior 34 contacts the lever arms 48 to pivot the blade retaining surfaces 38,40 relative to one another. The interaction of these components can be modified, made integral or separated into individual components, as understood by those skilled in the art.

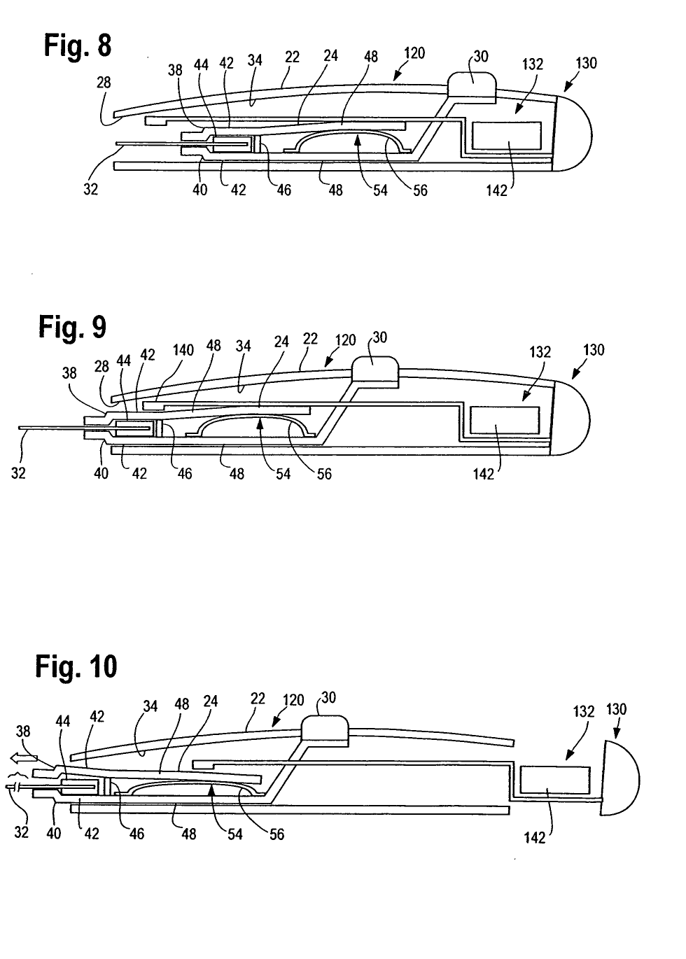

The embodiment illustrated in FIGS. 8-10 operates somewhat similarly to the embodiment described above, though the overall operation is modified. As described for the embodiment in FIG. 2, scraper 120 in FIG. 8 is in the retracted position whereby the blade 32 is substantially within the housing 22 and the blade retracting mechanism 24 and actuator 30 is positioned away from the blade opening 28. The biasing member 54 provides force to the retaining portion 26 to secure the blade 32 when in the retracted position.

As shown in FIG. 9, the scraper 120 has been manipulated to the working position whereby the actuator 30 and retracting mechanism have been moved towards the blade opening 28. In this position, the extension arms 138 and/or the cross member 140 can be utilized to provide additional force to secure the blade 32. In this manner, the extension arms 138 and/or the cross member 140 contacts the blade retaining surfaces 38,40 at a location relative to the pivot 46 such that a clamping force is provided to the blade 32. However, it should be understood that the interior 34 of the housing 22 can be shaped to also, or alternatively, provide clamping force, as described regarding FIG. 3. Similarly, protrusions 36 may be included to provide clamping force.

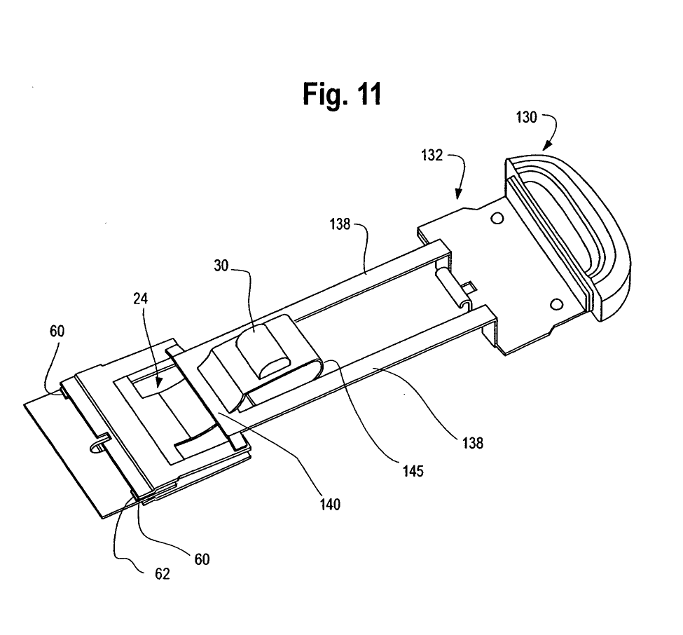

Referring to FIG. 10, the scraper 120 has been manipulated to the blade releasing position. This position is somewhat different compared to that shown for scraper 20 in FIG. 4. Scraper 120 is manipulated to the blade releasing position by moving the second actuator 130 away from the blade opening 28. In this manner, the extension arms 138 and/or the cross member 140 contact the blade retaining surface 38, such as at the lever arm 48, in cooperation with the interior 34 contacting the blade retaining surface 40, pivot the blade retaining surfaces 38,40 with respect to one another. The blade 32 can then be removed in similar manners as described above regarding scraper 20.

Furthermore, the embodiment illustrated in FIG. 10 can also be designed such that the actuator 30 can be manipulated even to move closer to the blade opening 28 than shown in FIG. 10 to provide better access to remove and replace the blade 32. In this form, the actuator 30 for scraper 120 would have three positions, similar to actuator 30 for scraper 20.

The scrapers 20,120 may also include additional functionality. For example, referring to FIGS. 6 and 11, scraper 120 includes bias member 145 to bias the actuator 30. When a user manipulates the actuator 30, the bias member 145 will provide force/resistance as the user moves the actuator 30. While the bias member is illustrated for scraper 120, it should be understood that it may also be utilized with scraper 20.

Similarly, while storage area 132 is illustrated with scraper 120, it may also be utilized with scraper 20. With scraper 120, the storage area 132 is accessed as the scraper 120 is manipulated to the blade releasing position shown in FIG. 10. Therefore, in a single motion from the working position to the blade releasing position, the scraper releases the blade 32 as well as provides access to stored blades in the storage area 132. Scraper 20, on the other hand would require movement of the actuator 30 to the blade releasing position and a separate movement to gain access to the storage area 132. Alternatively, the storage area 132 could be coupled to the actuator 30 such that a single motion manipulates the scraper 20 to the blade releasing position and provide access to the storage area 132, as understood by those skilled in the art.

The scrapers 20,120 can be made from a variety of materials, as understood by those skilled in the art. Suitable materials include, but are not limited to plastic, metal, rubber and the like or combinations thereof. Furthermore, the components described above can be manufactured as integral units or as combinations of parts assembled together to form the described components, as understood by those skilled in the art. For example, the housing 22 can be made as a single formed or molded piece or may be made of individual components, such as a top and bottom piece, that are subsequently assembled together. The overall assembly of the scrapers 20,120 should be understood by those skilled in the art in view of the figures and descriptions contained herein.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

1. A tool for releasably securing a blade, the tool comprising:
a housing;
a blade retracting mechanism movable between a retracted position and a working position;
a blade retaining portion located on the blade retracting mechanism, the blade retaining portion having at least two blade retaining surfaces cooperating to releasably secure the blade to the blade retracting mechanism, the blade retaining surfaces being located a first distance from one another in a blade retaining position and located a second distance from one another in a blade releasing position, the second distance being greater than the first distance;
a blade opening defined by the housing for inserting and removing the blade from the blade retaining portion; and,
an actuator for manipulating the blade retaining mechanism between the retracted position and the working position.

2. The tool of claim 1 wherein the blade is substantially enclosed within the housing and is located inwardly relative to the blade opening when in the retracted position.

3. The tool of claim 1 wherein the actuator is a button operably coupled to the blade retracting mechanism.

4. The tool of claim 1 further comprising a storage drawer and an extension arm extending therefrom, wherein the actuator is the drawer operably coupled to the blade retracting mechanism via the extension arm.

5. The tool of claim 1 wherein the blade retaining portion includes a lever arm to manipulate at least one of the blade retaining surfaces.

6. The tool of claim 5 wherein the lever arm contacts a portion of the housing to pivot at least one of the blade retaining surfaces to the blade releasing position.

7. The tool of claim 5 further comprising a storage drawer and an extension arm extending therefrom, wherein the arm contacts a portion of the extension arm to pivot at least one of the blade retaining surfaces to the blade releasing position.

8. The tool of claim 1 wherein the blade retaining surfaces are biased to the blade retaining position by a spring.

9. The tool of claim 1 wherein the blade retaining surfaces are capable of being moved from the blade retaining position to the blade releasing position when the blade retracting mechanism is in the working position.

10. A tool for releasably securing a blade, the tool comprising:
a housing;
a blade retracting mechanism movable between a retracted position and a working position;
a blade retaining portion located on the blade retracting mechanism, the blade retaining portion having at least two blade retaining surfaces movable between a blade releasing position and a blade retaining position;
a blade opening defined by the housing for inserting and removing the blade from the blade retaining portion;
a first actuator for manipulating the blade retracting mechanism between the retracted position and the working position; and,
a second actuator for manipulating the blade retaining surfaces between the blade releasing position and the blade retaining position.

11. The tool of claim 10 wherein the blade is substantially enclosed within the housing and is located inwardly relative to the blade opening when in the retracted position.

12. The tool of claim 10 wherein the first actuator is a button operably coupled to the blade retracting mechanism.

13. The tool of claim 10 further comprising a storage drawer and an extension arm extending therefrom, wherein the second actuator is the drawer operably coupled to at least one of the blade retaining portions via the extension arm.

14. The tool of claim 10 wherein the blade retaining portion includes a lever arm to manipulate at least one of the blade retaining surfaces.

15. The tool of claim 14 further comprising a storage drawer and an extension arm extending therefrom, wherein the arm contacts a portion of the extension arm to pivot at least one of the blade retaining surfaces to the blade releasing position.

16. The tool of claim 10 wherein the blade retaining surfaces are biased to the blade retaining position by a spring.

17. A tool for releasably securing a blade, the tool comprising:
a housing;
a blade retracting mechanism movable between a retracted position, a working position and a blade releasing position;
a blade retaining portion located on the blade retracting mechanism, the blade retaining portion having at least two blade retaining surfaces movable between the blade releasing position and a blade retaining position;
a blade opening defined by the housing for inserting and removing the blade from the blade retaining portion;
an actuator for manipulating the blade retracting mechanism between the retracted position, the working position and the blade releasing position.

18. The tool of claim 17 wherein the blade is substantially enclosed within the housing and is located inwardly relative to the blade opening when in the retracted position.

19. The tool of claim 17 wherein the actuator is a button operably coupled to the blade retracting mechanism to manipulate the blade retracting mechanism between the retracted position, the working position and the blade release position.

20. The tool of claim 17 wherein the blade retaining portion includes a lever arm to manipulate at least one of the blade retaining surfaces.

21. The tool of claim 20 wherein the lever arm contacts a portion of the housing to pivot at least one of the blade retaining surfaces to the blade releasing position.

22. The tool of claim 17 wherein the blade retaining surfaces are biased to the blade retaining position by a spring.
